(19) United States
(12) Patent Application Publication
(10) Pub. No.: US 2021/0284487 A1
(43) Pub. Date: Sep. 16, 2021

(54) DEVICES, METHODS AND COMPUTER PROGRAMS FOR MONITORING, PROCESSING AND ADJUSTING AN ELEVATOR EMERGENCY STOPPING EVENT

(71) Applicant: Kone Corporation, Helsinki (FI)

(72) Inventors: Ari JUSSILA, Helsinki (FI); Toni HIRVONEN, Helsinki (FI)

(73) Assignee: Kone Corporation, Helsinki (FI)

(21) Appl. No.: 17/177,615

(22) Filed: Feb. 17, 2021

(30) Foreign Application Priority Data
Mar. 12, 2020 (EP) 20162750.2

(51) Int. Cl. B66B 1/28; B66B 1/34; B66B 5/04; B66B 5/02

(52) U.S. Cl. CPC B66B 1/28; B66B 1/3461; B66B 1/3407; B66B 5/02; B66B 1/3476; B66B 5/04; B66B 1/3492

(57) ABSTRACT

Devices, methods and computer programs for monitoring, processing and/or adjusting of elevator emergency stopping events are disclosed. At least some of the disclosed embodiments allow measuring automatically the performance of an elevator emergency stopping event protection function, and the invention can be utilized together with manual checks for adjusting parametrization of the elevator emergency stopping event protection function. The invention further allows separate safety parameters for up and down direction. Measurements can be done separately to both directions and related safety parameters can be adjusted based on those.

### RELATED APPLICATIONS

This application claims priority to European Patent Application No. 20162750.2 filed on Mar. 12, 2020, the entire contents of which are incorporated herein by reference.

### TECHNICAL FIELD

The present disclosure relates to the field of elevators, and, more particularly, to monitoring, processing and/or adjusting of elevator emergency stopping events, and related devices, methods and computer programs.

### BACKGROUND

Elevators have electromechanical brakes that apply to a traction sheave or rotating axis of a hoisting machine to stop movement of the hoisting machine and therefore an elevator car driven by the hoisting machine. A hoisting machine normally has two electromechanical brakes. The brakes are typically dimensioned to stop and hold an elevator car with 125% load (i.e. 25% overload) in case of an emergency stopping event. Braking torque is relative to friction between brake pads and brake linings. Thus, wear of brake pads may cause decrease of friction/braking torque, and thus increase of a braking distance in connection with an emergency stopping event.

Traditionally an elevator is driven with steel ropes running via the traction sheave of the hoisting machine. When hoisting machinery brakes are closed to stop elevator car movement, steel ropes slip on the traction sheave. The slipping may be extensive if the friction between the ropes and the traction sheave decreases, for example if there is not enough rope grease in the ropes.

Recently, new kind of coated hoisting ropes have been introduced. These may be e.g. traditional round steel ropes with a high-friction coating, or belts with high-friction coating, such as a polyurethane coating. Load-carrying parts of the belts may be steel cords or they can be made of synthetic fibers, such as glass fibers or carbon fibers, for example.

These new kind of coated hoisting ropes cause a higher friction between the ropes and the traction sheave. Reduction in slipping of the ropes on the traction sheave may lead to extensive deceleration of the elevator car in the emergency stopping situation, which may be a non-desired condition for elevator passengers.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the present disclosure to allow monitoring, processing and/or adjusting of elevator emergency stopping events. The foregoing and other objects are achieved by the features of the independent claims. Further implementation forms are apparent from the dependent claims, the description and the figures.

According to a first aspect of the disclosure, an elevator control unit is provided. The elevator control unit comprises at least one processor, and at least one memory including computer program code. The at least one memory and the computer program code are configured to, with the at least one processor, cause the elevator control unit at least to perform:

triggering an emergency stopping event of an elevator car of an elevator system in response to fulfillment of an emergency stopping criterion;

recording data about the emergency stopping event;

transmitting, via a communication link, the recorded data about the emergency stopping event to a processing unit external to the elevator control unit;

receiving, from the processing unit via the communication link, information related to performance of the emergency stopping event responsive to the transmitted recorded data about the emergency stopping event; and

adjusting at least one parameter related to the emergency stopping event based on the received information related to the performance of the emergency stopping event.

In an implementation form of the first aspect, the at least one memory and the computer program code are further configured to, with the at least one processor, cause the elevator control unit to perform transmitting, via the communication link, recorded data about at least two consecutive emergency stopping events of the elevator car to the processing unit.

In an implementation form of the first aspect, the information related to the performance of the emergency stopping event comprises an instruction to adjust the at least one parameter related to the emergency stopping event.

In an implementation form of the first aspect, the recorded data about the emergency stopping event comprises at least one of:

a position of the elevator car at the triggering moment of the emergency stopping event;

speed of the elevator car at the triggering moment of the emergency stopping event;

a stopping position of the elevator car in the emergency stopping event;

a stopping distance of the elevator car in the emergency stopping event;

buffer impact speed of the elevator car in the emergency stopping event;

deceleration of a traction sheave or the elevator car during the emergency stopping event;

acceleration of the traction sheave or the elevator car during the emergency stopping event;

moving direction of the elevator car during the emergency stopping event;

elevator car load during the emergency stopping event; or

an elevator system state associated with the emergency stopping event.

In an implementation form of the first aspect, the at least one parameter related to the emergency stopping event comprises at least one of:

a triggering limit of the emergency stopping event;

target deceleration of a traction sheave or the elevator car during the emergency stopping event; or

time information related to scheduling of elevator system maintenance.

According to a second aspect of the disclosure, an elevator system is provided. The elevator system comprises the elevator control unit according to the first aspect.

According to a third aspect of the disclosure, a method is provided. The method comprises triggering, by an elevator control unit, an emergency stopping event of an elevator car of an elevator system in response to fulfillment of an emergency stopping criterion. The method further comprises recording, by the elevator control unit, data about the emergency stopping event. The method further comprises transmitting, from the elevator control unit via a communication link, the recorded data about the emergency stopping event to a processing unit external to the elevator control unit. The method further comprises receiving, at the elevator control unit from the processing unit via the communication link, information related to performance of the emergency stopping event responsive to the transmitted recorded data about the emergency stopping event. The method further comprises adjusting, by the elevator control unit, at least one parameter related to the emergency stopping event based on the received information related to the performance of the emergency stopping event.

In an implementation form of the third aspect, the method further comprises transmitting, via the communication link, recorded data about at least two consecutive emergency stopping events of the elevator car to the processing unit.

In an implementation form of the third aspect, the information related to the performance of the emergency stopping event comprises an instruction to adjust the at least one parameter related to the emergency stopping event.

In an implementation form of the third aspect, the recorded data about the emergency stopping event comprises at least one of:

a position of the elevator car at the triggering moment of the emergency stopping event;

speed of the elevator car at the triggering moment of the emergency stopping event;

a stopping position of the elevator car in the emergency stopping event;

a stopping distance of the elevator car in the emergency stopping event;

buffer impact speed of the elevator car in the emergency stopping event;

deceleration of a traction sheave or the elevator car during the emergency stopping event;

acceleration of the traction sheave or the elevator car during the emergency stopping event;

moving direction of the elevator car during the emergency stopping event;

elevator car load during the emergency stopping event; or

an elevator system state associated with the emergency stopping event.

In an implementation form of the third aspect, the at least one parameter related to the emergency stopping event comprises at least one of:

a triggering limit of the emergency stopping event;

target deceleration of a traction sheave or the elevator car during the emergency stopping event; or

time information related to scheduling of elevator system maintenance.

According to a fourth aspect of the disclosure, a computer program product is provided. The computer program product comprises code configured to perform the method according to the third aspect when the computer program product is executed on the elevator control unit.

According to a fifth aspect of the disclosure, a processing unit is provided. The processing unit comprises at least one processor, and at least one memory including computer program code. The at least one memory and the computer program code are configured to, with the at least one processor, cause the processing unit at least to perform:

receiving, from an elevator control unit via a communication link, recorded data about an emergency stopping event of an elevator car of an elevator system caused in response to fulfillment of an emergency stopping criterion;

processing the received recorded data about the emergency stopping event; and

generating information related to performance of the emergency stopping event based on results of the processing of the received recorded data about the emergency stopping event.

In an implementation form of the fifth aspect, the at least one memory and the computer program code are further configured to, with the at least one processor, cause the processing unit to perform:

receiving, from the elevator control unit via the communication link, recorded data about at least two consecutive emergency stopping events of the elevator car;

processing the received recorded data about the at least two consecutive emergency stopping events; and

generating the information related to performance of the emergency stopping event based on results of the processing of the received recorded data about the at least two consecutive emergency stopping events.

In an implementation form of the fifth aspect, the at least one memory and the computer program code are further configured to, with the at least one processor, cause the processing unit to perform transmitting, via the communication link, the generated information related to the performance of the emergency stopping event to the elevator control unit.

In an implementation form of the fifth aspect, the generated information related to the performance of the emergency stopping event comprises an instruction to adjust at least one parameter related to the emergency stopping event.

In an implementation form of the fifth aspect, the at least one parameter related to the emergency stopping event comprises at least one of:

a triggering limit of the emergency stopping event;

target deceleration of a traction sheave or the elevator car during the emergency stopping event; or

time information related to scheduling of elevator system maintenance.

In an implementation form of the fifth aspect, the at least one memory and the computer program code are further configured to, with the at least one processor, cause the processing unit to perform generating a service request for the elevator system based on the generated information related to the performance of the emergency stopping event.

In an implementation form of the fifth aspect the received recorded data about the emergency stopping event comprises at least one of:

a position of the elevator car at the triggering moment of the emergency stopping event;

speed of the elevator car at the triggering moment of the emergency stopping event;

a stopping position of the elevator car in the emergency stopping event;

a stopping distance of the elevator car in the emergency stopping event;

buffer impact speed of the elevator car in the emergency stopping event;

deceleration of a traction sheave or the elevator car during the emergency stopping event;

acceleration of the traction sheave or the elevator car during the emergency stopping event;

moving direction of the elevator car during the emergency stopping event;

elevator car load during the emergency stopping event; or

an elevator system state associated with the emergency stopping event.

According to a sixth aspect of the disclosure, a method is provided. The method comprises receiving, at a processing unit from an elevator control unit via a communication link, recorded data about an emergency stopping event of an elevator car of an elevator system caused in response to fulfillment of an emergency stopping criterion. The method further comprises processing, by the processing unit, the received recorded data about the emergency stopping event. The method further comprises generating, by the processing unit, information related to performance of the emergency stopping event based on results of the processing of the received recorded data about the emergency stopping event.

In an implementation form of the sixth aspect, the method further comprises receiving, from the elevator control unit via the communication link, recorded data about at least two consecutive emergency stopping events of the elevator car. The method further comprises processing the received recorded data about the at least two consecutive emergency stopping events. The method further comprises generating the information related to performance of the emergency stopping event based on results of the processing of the received recorded data about the at least two consecutive emergency stopping events.

In an implementation form of the sixth aspect, the method further comprises transmitting, via the communication link, the generated information related to the performance of the emergency stopping event to the elevator control unit.

In an implementation form of the sixth aspect, the generated information related to the performance of the emergency stopping event comprises an instruction to adjust at least one parameter related to the emergency stopping event.

In an implementation form of the sixth aspect, the at least one parameter related to the emergency stopping event comprises at least one of:

a triggering limit of the emergency stopping event;

target deceleration of a traction sheave or the elevator car during the emergency stopping event; or

time information related to scheduling of elevator system maintenance.

In an implementation form of the sixth aspect, the method further comprises generating a service request for the elevator system based on the generated information related to the performance of the emergency stopping event.

In an implementation form of the sixth aspect, the received recorded data about the emergency stopping event comprises at least one of:

a position of the elevator car at the triggering moment of the emergency stopping event;

speed of the elevator car at the triggering moment of the emergency stopping event;

a stopping position of the elevator car in the emergency stopping event;

a stopping distance of the elevator car in the emergency stopping event;

buffer impact speed of the elevator car in the emergency stopping event;

deceleration of a traction sheave or the elevator car during the emergency stopping event;

acceleration of the traction sheave or the elevator car during the emergency stopping event;

moving direction of the elevator car during the emergency stopping event;

elevator car load during the emergency stopping event; or

an elevator system state associated with the emergency stopping event.

According to a seventh aspect of the disclosure, a computer program product is provided. The computer program product comprises code configured to perform the method according to the sixth aspect when the computer program product is executed on the processing unit.

The invention allows monitoring, processing and/or adjusting of elevator emergency stopping events. The invention allows measuring automatically the performance of an elevator emergency stopping event protection function, and the invention can be utilized together with manual checks for adjusting parametrization of the elevator emergency stopping event protection function. The invention further allows separate safety parameters for up and down direction. Measurements can be done separately to both directions and related safety parameters can be adjusted based on those. Since the monitoring may take place in an external tool, such as a cloud computing system, a server, an edge computing unit, a mobile device or the like, a high safety level of the emergency stopping event may be maintained. Furthermore, since at least some of the embodiments make it possible to determine and monitor triggering sensitivity (i.e. sensitivity to triggering faults of the emergency stopping event), unnecessary fault triggering and/or entrapment of passengers may be prevented.

Many of the features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 is a block diagram illustrating an elevator system;

FIG. 2A is a block diagram illustrating an elevator control unit according to an embodiment of the present disclosure;

FIG. 2B is a block diagram illustrating a processing unit according to an embodiment of the present disclosure;

FIG. 3 is a flow diagram illustrating methods according to an embodiment of the present disclosure; and

FIG. 4 is a diagram illustrating a limit curve.

In the following, identical reference signs refer to identical or at least functionally equivalent features.

### DETAILED DESCRIPTION

In the following description, reference is made to the accompanying drawings, which form part of the disclosure, and in which are shown, by way of illustration, specific aspects in which the invention may be placed. It is understood that other aspects may be utilized, and structural or logical changes may be made without departing from the scope of the invention. The following detailed description, therefore, is not to be taken in a limiting sense, as the scope of the invention is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus or device is described based on functional units, a corresponding method may include a step performing the described functionality, even if such step is not explicitly described or illustrated in the figures. Further, it is understood that the features of the various example aspects described herein may be combined with each other, unless specifically noted otherwise.

The present disclosure is related to monitoring, processing and/or adjusting of elevator emergency stopping events, including monitoring the performance of an emergency stopping event of an elevator. One or more parameters related to the emergency stopping event may then be adjusted based on the monitoring. Also, e.g. a maintenance visit of the elevator may be scheduled based on the monitoring.

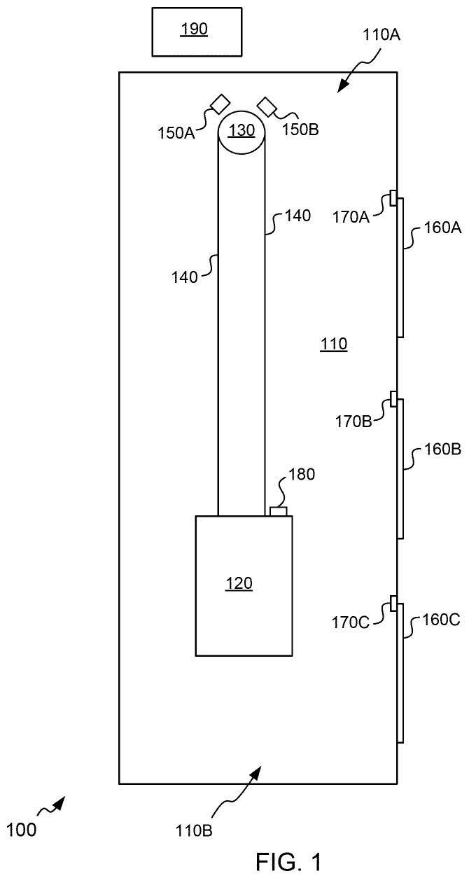

In the following, a general description of an elevator system 100 in which various embodiments of the present disclosure may be implemented is provided with reference to FIG. 1.

The elevator system 100 comprises an elevator shaft 110 defined by surrounding walls and top end terminal 110A and bottom end terminal 110B. The elevator system 100 further comprises an elevator car 120 that is vertically movable in the elevator shaft 110. The elevator system 100 further comprises an elevator hoisting machinery 130 that is adapted to drive the elevator car 120. The elevator system 100 further comprises electromechanical brakes 150A, 150B that are configured to brake movement of the elevator car 120. That is, the electromechanical brakes 150A, 150B may apply e.g. to a traction sheave or a rotating axis of the hoisting machinery 130 to stop movement of the hoisting machinery 130 and therefore the elevator car 120 driven by the hoisting machinery 130. A hoisting machinery 130 normally has two electromechanical brakes. However, any number of electromechanical brakes may be used. The elevator car 120 may be driven with e.g. steel ropes 140 running via the traction sheave of the hoisting machinery 130. Alternatively, e.g. coated hoisting ropes (such as steel ropes with a high-friction coating or belts with a high-friction coating) may be used. The elevator system 100 may further comprise a counterweight (not illustrated in FIG. 1).

The elevator system 100 may further comprise a first measuring device 180 that is adapted to provide first position data and first speed data of the elevator car 120. The first measuring device 180 may comprise e.g. a pulse sensor unit. The first measuring device 180 may be disposed in a suitable position in the elevator system. For example, the first measuring device 180 may be mounted to suitable elevator components, such as to the elevator car 120, to an overspeed governor, to a guide roller of the elevator car 120, and/or at one or more elevator landings.

The elevator system 100 may further comprise a second measuring device 170A, 170B, 170C that is adapted to provide at least a second position data of the elevator car 120. The second measuring device 170A, 170B, 170C may comprise e.g. a door zone sensor which may have e.g. a magnet, a signal strip or the like disposed in the shaft 110 such that it is capable of indicating the position of the elevator car 120 within a landing door zone 160A, 160B, 160C. The elevator system 100 may further comprise a safety monitoring unit 190 that is communicatively connected to the first measuring device 180 and the second measuring device 170A, 170B, 170C. The safety monitoring unit 190 may be configured to determine a synchronized position of the elevator car 120 from the first and the second position data. Herein, the term “synchronized position” means position data provided by the first measuring device 180 and then verified and, if necessary, also corrected by means of independent position data from the second measuring device 160A, 160B, 160C, to improve reliability and accuracy and thus safety of the position data. The safety monitoring unit 190 may comprise an ETSL (emergency terminal speed limiting) device.

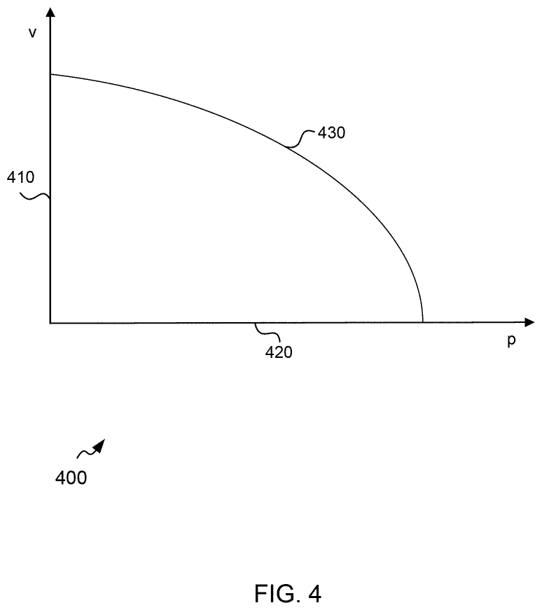

The safety monitoring unit 190 may be further configured to determine an emergency stopping event of the elevator car 120 in the proximity of the top 110A or the bottom 110B end terminal from the first speed data and from the synchronized position of the elevator car 120. An emergency stopping may be triggered when elevator car speed at a concurrent position of the elevator car 120 exceeds a triggering limit. The triggering limit may comprise e.g. a limit curve, such as the limit curve 430 of diagram 400 of FIG. 4 which is designed such that an overspeed limit 410 in the limit curve decreases towards the elevator shaft ends (i.e. as a function of the position 420 of the elevator car).

The safety monitoring unit 190 may be further configured to cause braking of the elevator car 120 with the electromechanical brakes 150A, 150B upon triggering of the emergency stopping event of the elevator car 120.

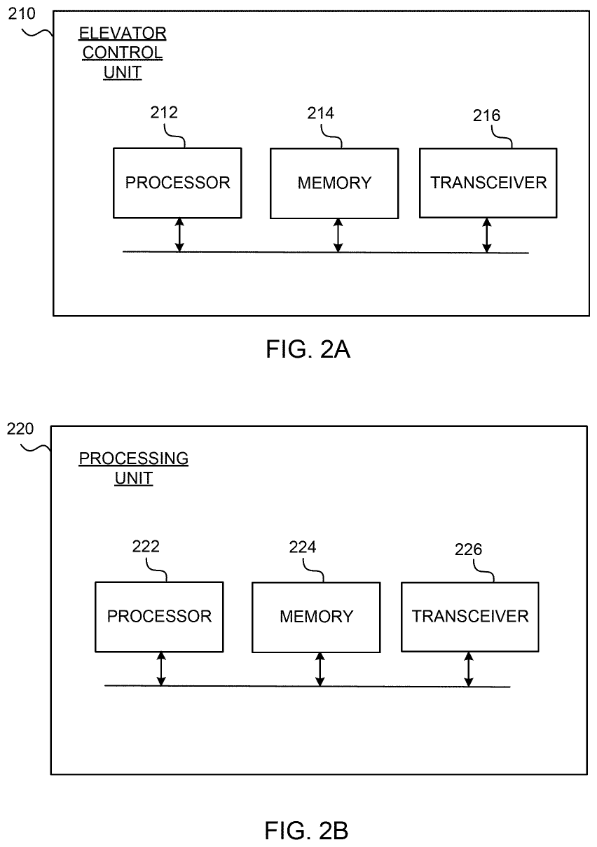

Next, example embodiments of an elevator control unit 210 and a processing unit 220 are described based on FIGS. 2A and 2B. Some of the features of the described units are optional features which provide further advantages.

FIG. 2A is a block diagram illustrating an elevator control unit 210 according to an embodiment of the present disclosure. In an embodiment, the elevator control unit 210 may comprise the safety monitoring unit 190 of FIG. 1.

The elevator control unit 210 comprises at least one processor or a processing unit 212, and at least one memory 214 including computer program code and coupled to the at least one processor 212, which may be used to implement the functionalities described later in more detail. The elevator control unit 210 may further comprise at least one transceiver 216 coupled to the at least one processor 212. The at least one transceiver 216 may comprise a wired transceiver and/or a wireless transceiver.

The at least one processor 212 may include, e.g., one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The at least one memory 214 may be configured to store e.g. computer programs and the like. The at least one memory 214 may include one or more volatile memory devices, one or more non-volatile memory devices, and/or a combination of one or more volatile memory devices and non-volatile memory devices. For example, the at least one memory 214 may be embodied as magnetic storage devices (such as hard disk drives, etc.), optical magnetic storage devices, and semiconductor memories (such as mask ROM, PROM (programmable ROM), EPROM (erasable PROM), flash ROM, RAM (random access memory), etc.).

The at least one memory 214 and the computer program code are configured to, with the at least one processor 212, cause the elevator control unit 210 to perform triggering an emergency stopping event of an elevator car of an elevator system in response to fulfillment of an emergency stopping criterion. The emergency stopping event may comprise an ETSL event.

The at least one memory 214 and the computer program code are further configured to, with the at least one processor 212, cause the elevator control unit 210 to perform recording data about the emergency stopping event. In an embodiment, the data about the emergency stopping event may be recorded in the at least one memory 214. Alternatively/additionally, the data about the emergency stopping event may be recorded in another memory/storage, such as a memory/storage external to the elevator control unit 210. In an embodiment, the recorded data about the emergency stopping event may comprise a position of the elevator car 120 at the triggering moment of the emergency stopping event. In an embodiment, the recorded data about the emergency stopping event may comprise speed of the elevator car 120 at the triggering moment of the emergency stopping event. In an embodiment, the recorded data about the emergency stopping event may comprise a stopping position of the elevator car 120 in the emergency stopping event. In an embodiment, the recorded data about the emergency stopping event may comprise a stopping distance (i.e. braking distance) of the elevator car 120 in the emergency stopping event. In an embodiment, the recorded data about the emergency stopping event may comprise buffer impact speed of the elevator car 120 in the emergency stopping event. In an embodiment, the recorded data about the emergency stopping event may comprise deceleration of a traction sheave or the elevator car 120 during the emergency stopping event or acceleration of the traction sheave or the elevator car 120 during the emergency stopping event (e.g. in case of a motor control error which may cause unwanted acceleration) thus helping to ensure that acceleration/deceleration remains within allowable maximum and minimum limit values. In an embodiment, the recorded data about the emergency stopping event may comprise a moving direction of the elevator car 120 during the emergency stopping event (since a nominal speed of the elevator car 120 may be direction dependent, buffer dimensioning may also be direction dependent). In an embodiment, the recorded data about the emergency stopping event may comprise an elevator car 120 load during the emergency stopping event. In an embodiment, the recorded data about the emergency stopping event may comprise an elevator system 100 state (e.g. normal operation or test operation) associated with the emergency stopping event.

The at least one memory 214 and the computer program code are further configured to, with the at least one processor 212, cause the elevator control unit 210 to perform transmitting, via a communication link (e.g. by utilizing the transceiver 216), the recorded data about the emergency stopping event to a processing unit 220. The processing unit 220 is external to the elevator control unit 210, and it will be discussed in more detail in connection with FIG. 2B. The communication link may comprise a wireless communication link and/or a wired communication link. In an embodiment, the data may be recorded about each emergency stop event during a given time period and then transmitted to the processing unit 220 in a batch.

In an embodiment, the at least one memory 214 and the computer program code may be further configured to, with the at least one processor 212, cause the elevator control unit 210 to perform transmitting, via the communication link, recorded data about at least two consecutive emergency stopping events of the elevator car 120 to the processing unit 220. Utilizing data about two or more consecutive emergency stopping events allows monitoring a change of the performance of the emergency stopping event and/or the rate of the change of the performance of the emergency stopping event.

The at least one memory 214 and the computer program code are further configured to, with the at least one processor 212, cause the elevator control unit 210 to perform receiving, from the processing unit 220 via the communication link (e.g. by utilizing the transceiver 216), information related to performance of the emergency stopping event, responsive to the transmitted recorded data about the emergency stopping event. For example, the information related to the performance of the emergency stopping event may comprise one or more instructions to adjust at least one parameter related to the emergency stopping event.

The at least one memory 214 and the computer program code are further configured to, with the at least one processor 212, cause the elevator control unit 210 to perform adjusting at least one parameter related to the emergency stopping event based on the received information related to the performance of the emergency stopping event. For example, the at least one parameter related to the emergency stopping event may comprise a triggering limit of the emergency stopping event, target deceleration of the traction sheave or the elevator car 120 during the emergency stopping event, and/or time information related to scheduling of elevator system maintenance.

FIG. 2B is a block diagram illustrating a processing unit 220 according to an embodiment of the present disclosure. In an embodiment, the processing unit 220 may comprise e.g. a cloud computing system, a server, an edge computing unit, a mobile device, a service/maintenance personnel device, or the like.

The processing unit 220 comprises at least one processor or a processing unit 222, and at least one memory 224 including computer program code and coupled to the at least one processor 222, which may be used to implement the functionalities described later in more detail. The processing unit 220 may further comprise at least one transceiver 226 coupled to the at least one processor 222. The at least one transceiver 226 may comprise a wired transceiver and/or a wireless transceiver.

The at least one processor 222 may include, e.g., one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The at least one memory 224 may be configured to store e.g. computer programs and the like. The at least one memory 224 may include one or more volatile memory devices, one or more non-volatile memory devices, and/or a combination of one or more volatile memory devices and non-volatile memory devices. For example, the at least one memory 224 may be embodied as magnetic storage devices (such as hard disk drives, etc.), optical magnetic storage devices, and semiconductor memories (such as mask ROM, PROM (programmable ROM), EPROM (erasable PROM), flash ROM, RAM (random access memory), etc.).

The at least one memory 224 and the computer program code are configured to, with the at least one processor 222, cause the processing unit 220 to perform receiving, from the elevator control unit 210 via a communication link (e.g. by utilizing the transceiver 226), recorded data about the emergency stopping event of the elevator car 120 of elevator system 100 caused in response to fulfillment of an emergency stopping criterion. As discussed above in connection with FIG. 2A, the emergency stopping event may comprise an ETSL event, and the received recorded data about the emergency stopping event may comprise at least one of a position of the elevator car 120 at the triggering moment of the emergency stopping event, speed of the elevator car 120 at the triggering moment of the emergency stopping event, a stopping position of the elevator car 120 in the emergency stopping event, a stopping distance of the elevator car 120 in the emergency stopping event, buffer impact speed of the elevator car 120 in the emergency stopping event, deceleration of a traction sheave or the elevator car 120 during the emergency stopping event, acceleration of the traction sheave or the elevator car 120 during the emergency stopping event, moving direction of the elevator car 120 during the emergency stopping event, elevator car 120 load during the emergency stopping event, or an elevator system 100 state associated with the emergency stopping event.

The at least one memory 224 and the computer program code are further configured to, with the at least one processor 222, cause the processing unit 220 to perform processing the received recorded data about the emergency stopping event.

The at least one memory 224 and the computer program code are further configured to, with the at least one processor 222, cause the processing unit 220 to perform generating information related to performance of the emergency stopping event based on results of the processing of the received recorded data about the emergency stopping event. For example, the generated information related to the performance of the emergency stopping event may comprise an instruction to adjust at least one parameter related to the emergency stopping event, and the at least one parameter related to the emergency stopping event may comprise at least one of a triggering limit of the emergency stopping event, target deceleration of a traction sheave or the elevator car during the emergency stopping event, or time information related to scheduling of elevator system maintenance.

In an embodiment, the at least one memory 224 and the computer program code may be further configured to, with the at least one processor 222, cause the processing unit 220 to perform receiving, from the elevator control unit 210 via the communication link, recorded data about at least two consecutive emergency stopping events of the elevator car; processing the received recorded data about the at least two consecutive emergency stopping events; and generating the information related to performance of the emergency stopping event based on results of the processing of the received recorded data about the at least two consecutive emergency stopping events.

The at least one memory 224 and the computer program code may be further configured to, with the at least one processor 222, cause the processing unit 220 to perform transmitting, via the communication link (e.g. by utilizing the transceiver 226), the generated information related to the performance of the emergency stopping event to the elevator control unit 210.

The at least one memory 224 and the computer program code may be further configured to, with the at least one processor 222, cause the processing unit 220 to perform generating a service request for the elevator system 100 based on the generated information related to the performance of the emergency stopping event.

In an embodiment, the user of the processing unit 220 may be required to have a predefined operator level to be able to adjust the parameters. In an embodiment in which the processing unit 220 comprises a cloud computing system, the parameter adjustment event may be initiated from a remote server of the cloud computing system, but on-site mechanical means (e.g. a stop switch) may also have to be manipulated.

In an embodiment, the at least one memory 224 and the computer program code may be further configured to, with the at least one processor 222, cause the processing unit 220 to perform simulating the impact of the emergency stopping event for a passenger in the elevator car 120 based on the received recorded data about the emergency stopping event and/or the generated information related to the performance of the emergency stopping event.

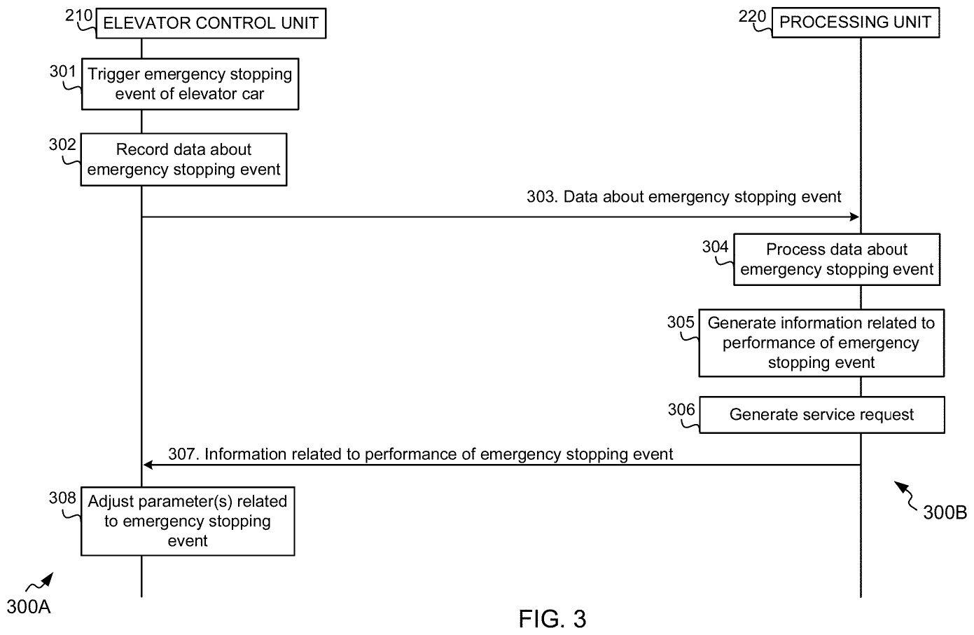

FIG. 3 is a flow diagram illustrating methods 300A, 300B according to an embodiment of the present disclosure.

At operation 301, an elevator control unit triggers an emergency stopping event of an elevator car of an elevator system in response to fulfillment of an emergency stopping criterion.

At operation 302, the elevator control unit records data about the emergency stopping event.

At operation 303, the elevator control unit transmits, via a communication link, the recorded data about the emergency stopping event to a processing unit external to the elevator control unit. Further at operation 303, the recorded data about the emergency stopping event of the elevator car is received at the processing unit.

At operation 304, the processing unit processes the received recorded data about the emergency stopping event.

At operation 305, the processing unit generates information related to performance of the emergency stopping event based on results of the processing of the received recorded data about the emergency stopping event.

At optional operation 306, the processing unit may generate a service request for the elevator system based on the generated information related to the performance of the emergency stopping event.

At operation 307, the processing unit transmits, via the communication link, the generated information related to the performance of the emergency stopping event to the elevator control unit. Further at operation 307, the information related to the performance of the emergency stopping event is received at the elevator control unit from the processing unit via the communication link.

At operation 308, the elevator control unit adjusts at least one parameter related to the emergency stopping event based on the received information related to the performance of the emergency stopping event.

The methods 300A, 300B may be performed by the elevator control unit 210 and the processing unit 220, respectively. The operations 301, 302, 303, 307, 308 can, for example, be performed by the at least one processor 212, the transceiver 216, and the memory 214. The operations 303, 304, 305, 306, 307 can, for example, be performed by the at least one processor 222, the transceiver 226, and the memory 224. Further features of the methods 300A, 300B directly result from the functionalities and parameters of the elevator control unit 210 and the processing unit 220 and thus are not repeated here. The methods 300A, 300B can be performed by a computer program.

The functionality described herein can be performed, at least in part, by one or more computer program product components such as software components. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Further, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of example embodiments. Although various embodiments have been described above with a certain degree of particularity, or with reference to one or more individual embodiments, those skilled in the art could make numerous alterations to the disclosed embodiments without departing from the scope of this specification.

1. An elevator control unit comprising:
at least one processor; and
at least one memory including computer program code;
wherein the at least one memory and the computer program code being configured to, with the at least one processor, cause the elevator control unit at least to perform:
triggering an emergency stopping event of an elevator car of an elevator system in response to fulfillment of an emergency stopping criterion;
recording data about the emergency stopping event;
transmitting, via a communication link, the recorded data about the emergency stopping event to a processing unit external to the elevator control unit;
receiving, from the processing unit via the communication link, information related to performance of the emergency stopping event responsive to the transmitted recorded data about the emergency stopping event; and
adjusting at least one parameter related to the emergency stopping event based on the received information related to the performance of the emergency stopping event.

2. The elevator control unit according to claim 1, wherein the at least one memory and the computer program code are further configured to, with the at least one processor, cause the elevator control unit to perform:
transmitting, via the communication link, recorded data about at least two consecutive emergency stopping events of the elevator car to the processing unit.

3. The elevator control unit according to claim 1, wherein the information related to the performance of the emergency stopping event comprises an instruction to adjust the at least one parameter related to the emergency stopping event.

4. The elevator control unit according to claim 1, wherein the recorded data about the emergency stopping event comprises at least one of:
a position of the elevator car at the triggering moment of the emergency stopping event;
speed of the elevator car at the triggering moment of the emergency stopping event;
a stopping position of the elevator car in the emergency stopping event;
a stopping distance of the elevator car in the emergency stopping event;
buffer impact speed of the elevator car in the emergency stopping event;
deceleration of a traction sheave or the elevator car during the emergency stopping event;
acceleration of the traction sheave or the elevator car during the emergency stopping event;
moving direction of the elevator car during the emergency stopping event;
elevator car load during the emergency stopping event; or
an elevator system state associated with the emergency stopping event.

5. The elevator control unit according to claim 1, wherein the at least one parameter related to the emergency stopping event comprises at least one of:
a triggering limit of the emergency stopping event;
target deceleration of a traction sheave or the elevator car during the emergency stopping event; or
time information related to scheduling of elevator system maintenance.

6. An elevator system comprising the elevator control unit according to claim 1.

7. A method, comprising
triggering, by an elevator control unit, an emergency stopping event of an elevator car of an elevator system in response to fulfillment of an emergency stopping criterion;
recording, by the elevator control unit, data about the emergency stopping event;
transmitting, from the elevator control unit via a communication link, the recorded data about the emergency stopping event to a processing unit external to the elevator control unit;
receiving, at the elevator control unit from the processing unit via the communication link, information related to performance of the emergency stopping event responsive to the transmitted recorded data about the emergency stopping event; and
adjusting, by the elevator control unit, at least one parameter related to the emergency stopping event based on the received information related to the performance of the emergency stopping event.

8. A computer program product comprising code configured to perform the method according to claim 7 when the computer program product is executed on the elevator control unit.

9. A processing unit comprising:
at least one processor; and
at least one memory including computer program code;
wherein the at least one memory and the computer program code being configured to, with the at least one processor, cause the processing unit at least to perform:
receiving, from an elevator control unit via a communication link, recorded data about an emergency stopping event of an elevator car of an elevator system caused in response to fulfillment of an emergency stopping criterion;
processing the received recorded data about the emergency stopping event; and
generating information related to performance of the emergency stopping event based on results of the processing of the received recorded data about the emergency stopping event.

10. The processing unit according to claim 9, wherein the at least one memory and the computer program code are further configured to, with the at least one processor, cause the processing unit to perform:
receiving, from the elevator control unit via the communication link, recorded data about at least two consecutive emergency stopping events of the elevator car;
processing the received recorded data about the at least two consecutive emergency stopping events; and
generating the information related to performance of the emergency stopping event based on results of the processing of the received recorded data about the at least two consecutive emergency stopping events.

11. The processing unit according to claim 9, wherein the at least one memory and the computer program code are further configured to, with the at least one processor, cause the processing unit to perform:
transmitting, via the communication link, the generated information related to the performance of the emergency stopping event to the elevator control unit.

12. The processing unit according to claim 9, wherein the generated information related to the performance of the emergency stopping event comprises an instruction to adjust at least one parameter related to the emergency stopping event.

13. The processing unit according to claim 12, wherein the at least one parameter related to the emergency stopping event comprises at least one of:
a triggering limit of the emergency stopping event;
target deceleration of a traction sheave or the elevator car during the emergency stopping event; or
time information related to scheduling of elevator system maintenance.

14. The processing unit according to claim 9, wherein the at least one memory and the computer program code are further configured to, with the at least one processor, cause the processing unit to perform:
generating a service request for the elevator system based on the generated information related to the performance of the emergency stopping event.

15. The processing unit according to claim 9, wherein the received recorded data about the emergency stopping event comprises at least one of:
a position of the elevator car at the triggering moment of the emergency stopping event;
speed of the elevator car at the triggering moment of the emergency stopping event;
a stopping position of the elevator car in the emergency stopping event;
a stopping distance of the elevator car in the emergency stopping event;
buffer impact speed of the elevator car in the emergency stopping event;
deceleration of a traction sheave or the elevator car during the emergency stopping event;
acceleration of the traction sheave or the elevator car during the emergency stopping event;
moving direction of the elevator car during the emergency stopping event;
elevator car load during the emergency stopping event; or
an elevator system state associated with the emergency stopping event.

16. A method comprising:
receiving, at a processing unit from an elevator control unit via a communication link, recorded data about an emergency stopping event of an elevator car of an elevator system caused in response to fulfillment of an emergency stopping criterion;
processing, by the processing unit, the received recorded data about the emergency stopping event; and
generating, by the processing unit, information related to performance of the emergency stopping event based on results of the processing of the received recorded data about the emergency stopping event.

17. A computer program product comprising code configured to perform the method according to claim 16 when the computer program product is executed on the processing unit.
